(19) United States
(12) Patent Application Publication
(10) Pub. No.: US 2018/0209437 A1
(43) Pub. Date: Jul. 26, 2018

(54) IMPELLER AND SUPERCHARGER

(71) Applicant: IHI Corporation, Koto-ku (JP)

(72) Inventors: Taiki YOSHIZAKI, Tokyo (JP); Koutarou ITOU, Tokyo (JP); Takashi YOSHIDA, Tokyo (JP); Takuya OZASA, Tokyo (JP); Kuniaki IIZUKA, Tokyo (JP)

(73) Assignee: IHI Corporation, Koto-ku (JP)

(21) Appl. No.: 15/937,100

(22) Filed: Mar. 27, 2018

Related U.S. Application Data
(63) Continuation of application No. PCT/JP2016/078660, filed on Sep. 28, 2016.

(30) Foreign Application Priority Data
Oct. 2, 2015 (JP) 2015-196472

(51) Int. Cl. F04D 29/28; F04D 29/30; F02B 39/10

(52) U.S. Cl. CPC F04D 29/284; F02B 39/10; F04D 29/30

(57) ABSTRACT

An impeller includes: a main body portion which is increased in diameter from one side to another side in a rotation axis direction; a thinned portion, which is formed in a back surface of the main body portion so as to be oriented toward the another side in the rotation axis direction, and is recessed toward the one side in the rotation axis direction; a plurality of full blades which are formed on an outer circumferential surface of the main body portion so as to be oriented toward the one side in the rotation axis direction; and a plurality of splitter blades, which are formed on the outer circumferential surface, and have end portions being located on the one side in the rotation axis direction and being positioned on the another side in the rotation axis direction with respect to the full blades.

### CROSS REFERENCE TO RELATED APPLICATIONS

This application is a continuation application of International Application No. PCT/JP2016/078660, filed on Sep. 28, 2016, which claims priority to Japanese Patent Application No. 2015-196472, filed on Oct. 2, 2015, the entire contents of which are incorporated by reference herein.

### BACKGROUND ART

### Technical Field

The present disclosure relates to an impeller, which includes a main body portion and a plurality of blades formed on an outer circumferential surface of the main body portion, and to a supercharger.

### Related Art

There has been known an electric supercharger that includes a rotor provided to a shaft and a stator provided on a housing side. In the electric supercharger, the shaft is driven to rotate by a magnetic force generated between the rotor and the stator. The electric supercharger is one type of superchargers. An impeller is provided to the shaft of the electric supercharger. When the shaft is rotated by the electric motor, the impeller is rotated together with the shaft. The electric supercharger compresses air along with the rotation of the impeller and delivers the compressed air to an engine.

The impeller of the supercharger includes a main body portion. The main body portion is increased in diameter from one side to another side in a rotation axis direction. A plurality of blades are formed on an outer circumferential surface of the main body portion. In an impeller described in Patent Literature 1, a thinned portion which is recessed toward one side in a rotation axis direction is formed in a back surface of a main body portion.

### CITATION LIST

### Patent Literature

Patent Literature 1: Japanese Patent Application Laid-Open No. 2-132820

### SUMMARY

### Technical Problem

As described in Patent Literature 1 mentioned above, the impeller is downweighted through the formation of the thinned portion in the back surface of the main body portion of the impeller. In such a manner, inertia of the impeller is reduced. A response performance of the impeller is improved. However, when the thinned portion is simply formed, the strength of the impeller is reduced. Therefore, a rib is formed at the thinned portion of the impeller described in Patent Literature 1 to improve the strength. The rib extends in a radial direction. However, when such a rib is formed, the rib receives air resistance. As a result, efficiency is degraded.

It is an object of the present disclosure to provide an impeller and a supercharger which are capable of achieving downweighting and securing the strength while suppressing degradation in efficiency.

### Solution to Problem

In order to solve the above-mentioned problem, according to one embodiment of the present disclosure, there is provided an impeller, including: a main body portion which is increased in diameter from one side to another side in a rotation axis direction; a thinned portion, which is formed in a back surface of the main body portion so as to be oriented toward the another side in the rotation axis direction, and is recessed toward the one side in the rotation axis direction; a plurality of full blades which are formed on an outer circumferential surface of the main body portion so as to be oriented toward the one side in the rotation axis direction; and a plurality of splitter blades, which are formed on the outer circumferential surface, and have end portions being located on the one side in the rotation axis direction and being positioned on the another side in the rotation axis direction with respect to the full blades.

The thinned portion may have a deepest portion, which is located at a position being the same as positions of the end portions of the splitter blades or may reach a position deeper than the end portions.

The impeller may further include: a cylindrical portion, which is formed on a back surface side of the main body portion, and protrudes toward the another side in the rotation axis direction with respect to the deepest portion of the thinned portion to serve as an outer wall of an insertion hole for receiving a shaft inserted to the insertion hole; and a rib, which is arranged apart from the cylindrical portion in a radial direction of the shaft, and protrudes from the back surface of the main body portion toward the another side in the rotation axis direction and extends in a circumferential direction of the shaft.

In order to solve the above-mentioned problem, according to another embodiment of the present disclosure, there is provided an impeller, including: a main body portion which is increased in diameter from one side to another side in a rotation axis direction; a plurality of blades which are formed on an outer circumferential surface of the main body portion so as to be oriented toward the one side in the rotation axis direction; and a thinned portion, which is formed in a back surface of the main body portion so as to be oriented toward the another side in the rotation axis direction, and is recessed toward the one side in the rotation axis direction; a cylindrical portion, which is formed on a back surface side of the main body portion, and protrudes toward the another side in the rotation axis direction with respect to a deepest portion of the thinned portion to serve as an outer wall of an insertion hole for receiving a shaft inserted to the insertion hole; and a rib, which is arranged apart from the cylindrical portion in a radial direction of the shaft, and protrudes from the back surface of the main body portion toward the another side in the rotation axis direction and extends in a circumferential direction of the shaft.

In order to solve the above-mentioned problem, according to one embodiment of the present disclosure, there is provided a supercharger, including the above-mentioned impeller.

### Effects of Disclosure

With the impeller and the supercharger according to the present disclosure, downweighting can be achieved, and the strength can be secured without degrading the efficiency.

### BRIEF DESCRIPTION OF DRAWINGS

FIG. 1 is a schematic sectional view of an electric supercharger (supercharger).

FIG. 2A is an external appearance perspective view of a compressor impeller.

FIG. 2B is a view as seen from the direction indicated by the arrow IIb of FIG. 2A.

FIG. 3 is a sectional view taken along a plane including a rotation axis of the compressor impeller.

FIG. 4 is an extraction view of the two-dot chain line portion of FIG. 3.

### DESCRIPTION OF EMBODIMENT

Now, with reference to the attached drawings, an embodiment of the present disclosure is described in detail. The dimensions, materials, and other specific numerical values represented in the embodiment are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

FIG. 1 is a schematic sectional view of an electric supercharger C (supercharger). In the following description, the direction indicated by the arrow L illustrated in FIG. 1 corresponds to a left side of the electric supercharger C, and the direction indicated by the arrow R illustrated in FIG. 1 corresponds to a right side of the electric supercharger C. As illustrated in FIG. 1, the electric supercharger C includes a supercharger main body 1. The supercharger main body 1 includes a motor housing 2. A compressor housing 4 is coupled to the left side of the motor housing 2 by a fastening bolt 3. A plate member 6 is coupled to the right side of the motor housing 2 by a fastening bolt 5. A cord housing 8 is coupled to the right side of the plate member 6 by a fastening bolt 7. The motor housing 2, the compressor housing 4, the plate member 6, and the cord housing 8 are integrated.

In the motor housing 2, there is formed a motor hole 2a that is opened on the right side in FIG. 1. In the motor hole 2a, an electric motor 9 is received. The electric motor 9 includes a stator 10 and a rotor 11. The stator 10 is formed by winding coils 13 on a stator core 12. The stator core 12 has a cylindrical shape.

A plurality of coils 13 are arranged in a circumferential direction of the stator core 12. The coils 13 are arranged in the order of U-phase, V-phase, and W-phase being phases of supplied alternate-current power. Lead wires 14 are provided to the U-phase, the V-phase, and the W-phase, respectively. One end of each of the lead wires 14 is coupled to each of the coils 13 of the U-phase, the V-phase, and the W-phase. The lead wires 14 supply the alternate-current power to the coils 13.

Further, the stator core 12 is inserted to the motor hole 2a from an opening side of the motor hole 2a. The stator core 12 is mounted in the motor hole 2a. An opening of the motor hole 2a on the right side is closed by the plate member 6. The cord housing 8 coupled to the plate member 6 has a cord hole 8a. The cord hole 8a penetrates in a right-and-left direction in FIG. 1. One end of the cord hole 8a is closed by the plate member 6. A plate hole 6a is formed in the plate member 6. The motor hole 2a and the cord hole 8a communicate with each other through the plate hole 6a. The lead wires 14 extend from the coils 13 to the cord hole 8a through the plate hole 6a.

The lead wires 14 are received in the cord hole 8a. Another end of each of the lead wires 14 on a side opposite to each of the coils 13 is coupled to a connector 15. The connector 15 has a flange portion 15a. The flange portion 15a closes another end of the cord hole 8a of the cord housing 8. The flange portion 15a is mounted to the cord housing 8 by a fastening bolt 16. The alternate-current power is supplied to the coils 13 of the stator 10 through the connector 15 and the lead wires 14. The stator 10 functions as an electromagnet.

Further, the rotor 11 is mounted to the shaft 17. The rotor 11 is inserted to the stator core 12. The rotor 11 has a gap with respect to the stator core 12 in a radial direction of the shaft 17. Specifically, the rotor 11 includes a rotor core 18. The rotor core 18 is a cylindrical member. The rotor core 18 has a hole penetrating in an axial direction of the shaft 17. A magnet 19 (permanent magnet) is received in the hole of the rotor core 18. The electric motor 9 generates a driving force in the rotation direction for the shaft 17 by a mutual force generated between the rotor 11 and the stator 10.

The shaft 17 is inserted to a housing hole 2b of the motor housing 2. The housing hole 2b penetrates in the axial direction of the shaft 17 through a wall portion 2c forming a bottom surface of the motor hole 2a. A ball bearing 20 is arranged in the housing hole 2b. The shaft 17 is axially supported by the ball bearing 20.

One end of the shaft 17, which protrudes toward the plate member 6 side with respect to the rotor 11, is inserted to a boss hole 6b. The boss hole 6b is formed in the plate member 6. An annular protrusion 6c is formed on the plate member 6. The annular protrusion 6c protrudes into the motor hole 2a. The annular protrusion 6c forms a part of an outer wall forming the boss hole 6b. A ball bearing 21 is arranged in the boss hole 6b. The shaft 17 is axially supported by the ball bearing 21.

Another end side of the shaft 17 protrudes from the housing hole 2b into the compressor housing 4. On a portion of the shaft 17, which protrudes into the compressor housing 4, a compressor impeller 22 (impeller) is provided. The compressor impeller 22 is received in the compressor housing 4 so as to be rotatable.

The compressor housing 4 has an intake port 23. The intake port 23 is opened on the left side of the electric supercharger C. The intake port 23 is connected to an air cleaner (not shown). Further, under a state in which the motor housing 2 and the compressor housing 4 are coupled to each other by the fastening bolt 3, a diffuser flow passage 24 is formed. The diffuser flow passage 24 is formed by opposed surfaces of the motor housing 2 and the compressor housing 4. The diffuser flow passage 24 increases the air in pressure. The diffuser flow passage 24 is annularly formed so as to extend from a radially inner side to a radially outer side of the shaft 17. On the above-mentioned radially inner side, the diffuser flow passage 24 communicates with the intake port 23 through intermediation of the compressor impeller 22.

Further, an annular compressor scroll flow passage 25 is provided to the compressor housing 4. The compressor scroll flow passage 25 is positioned on the radially outer side of the shaft 17 with respect to the diffuser flow passage 24. The compressor scroll flow passage 25 communicates with an intake port of an engine (not shown). The compressor scroll flow passage 25 communicates also with the diffuser flow passage 24.

The driving force generated by the electric motor 9 causes the compressor impeller 22 to rotate. The rotation of the compressor impeller 22 causes air to be sucked into the compressor housing 4. The air is sucked through the intake port 23 in the axial direction of the shaft 17. The sucked air is increased in speed by an action of a centrifugal force in the course of flowing through between blades of the compressor impeller 22 (through between a plurality of blades 27 described later). The air having been increased in speed is delivered to the diffuser flow passage 24 and the compressor scroll flow passage 25, and is increased in pressure (compressed). The air having been increased in pressure is led to the intake port of the engine.

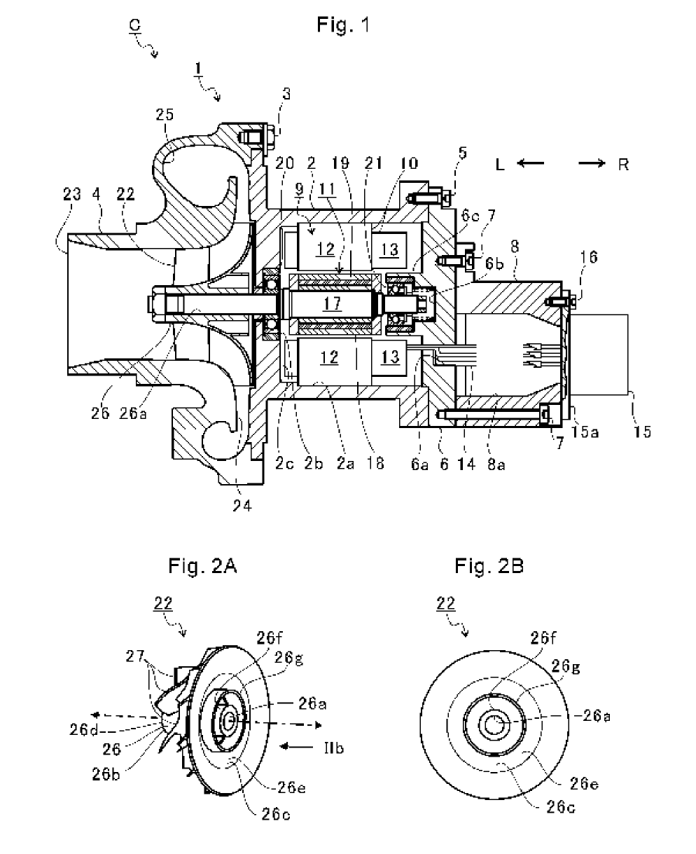

FIG. 2A is an external appearance perspective view of the compressor impeller 22. FIG. 2B is a view as seen from the direction indicated by the arrow IIb of FIG. 2A.

The compressor impeller 22 is made of, for example, carbon fiber reinforced plastic (CFRP). As illustrated in FIG. 2A, the compressor impeller 22 includes a main body portion 26 and a plurality of blades 27. The main body portion 26 is increased in diameter from one side (indicated by the broken line arrow on the left side in FIG. 2A) to another side (indicated by the one-dot chain line arrow on the right side in FIG. 2A) in a rotation axis direction. The main body portion 26 has an insertion hole 26a. The insertion hole 26a penetrates through the main body portion 26 in an axis direction of a rotation axis (hereinafter referred to as “rotation axis direction”) about which the compressor impeller 22 rotates. That is, the insertion hole 26a penetrates through the main body portion 26 in an axial direction of the shaft 17. The shaft 17 is inserted to the insertion hole 26a (see FIG. 1).

The main body portion 26 has an outer circumferential surface 26b which is oriented toward the one side in the rotation axis direction. The main body portion 26 has a back surface 26c which is oriented toward the another side in the rotation axis direction. The outer circumferential surface 26b and the back surface 26c have a circular outer shape as seen from the rotation axis direction.

The outer circumferential surface 26b of the main body portion 26 is gradually increased in outer diameter toward the another side in the rotation axis direction.

The outer circumferential surface 26b has the plurality of blades 27. The plurality of blades 27 are separated apart in a circumferential direction of the outer circumferential surface 26b. The plurality of blades 27 protrude in a radial direction from the outer circumferential surface 26b. The plurality of blades 27 extend in a direction of inclining in the circumferential direction of the outer circumferential surface 26b with respect to the rotation axis direction of the compressor impeller 22.

The back surface 26c of the main body portion 26 has a thinned portion 26e. The thinned portion 26e is a portion which is recessed toward a front end surface 26d side. The front end surface 26d is formed at a distal end of the main body portion 26 on the one side in the rotation axis direction. The back surface 26c is a part of an inner wall of the thinned portion 26e. For example, the thinned portion 26e is formed so that the portion at which the back surface 26c is formed has a substantially constant thickness.

The thinned portion 26e has a cylindrical portion 26f. The cylindrical portion 26f protrudes from an inner circumferential surface of the thinned portion 26e toward the back surface 26c side in the rotation axis direction of the compressor impeller 22 (another side of the rotation axis). The insertion hole 26a is formed on an inner circumference side of the cylindrical portion 26f. That is, the cylindrical portion 26f serves as an outer wall of a portion of the insertion hole 26a on the back surface 26c side.

The thinned portion 26e has a rib 26g on a radially outer side of the main body portion 26 with respect to the cylindrical portion 26f. As illustrated in FIG. 2A and FIG. 2B, the rib 26g is formed into an annular shape. The rib 26g is arranged apart from the cylindrical portion 26f in the radial direction of the main body portion 26.

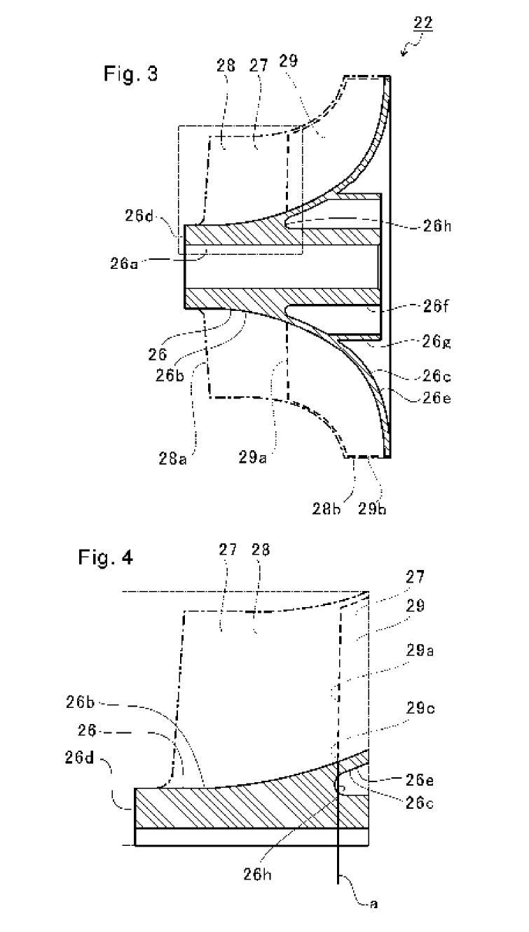

FIG. 3 is a sectional view taken along a plane including the rotation axis of the compressor impeller 22. In FIG. 3, the blades 27 are illustrated with respective shapes obtained as a result of projection in the rotation direction of the compressor impeller 22 (meridional shape).

As illustrated in FIG. 3, the cylindrical portion 26f protrudes from a deepest portion 26h of the thinned portion 26e toward the back surface 26c side along the rotation axis direction.

The plurality of blades 27 include full blades 28 (indicated by the one-dot chain lines in FIG. 3) and splitter blades 29 (indicated by the broken lines in FIG. 3). The full blades 28 and the splitter blades 29 protrude so as to approach a radially outer side from the outer peripheral surface 26b as extending from the one side (front end surface 26d side) toward the another side (back surface 26c side) in the rotation axis direction. End portions 29a of the splitter blades 29 on the one side in the rotation axis direction are located on the another side in the rotation axis direction with respect to end portions 28a of the full blades 28 on the one side in the rotation axis direction. The splitter blades 29 have smaller length in the rotation axis direction than the full blades 28. The full blades 28 and the splitter blades 29 are arranged alternately in the circumferential direction (rotation direction) of the outer circumferential surface 26b.

End portions 28b of the full blades 28 on the radially outer side of the outer circumferential surface 26b of the main body portion 26 and end portions 29b of the splitter blades 29 on the radially outer side of the outer circumferential surface 26b of the main body portion 26 extend to substantially the same positions in the radial direction and in the rotation axis direction.

Now, simple description is made of a flow of air around the compressor impeller 22. Air having flowed in through the intake port 23 flows from the end portion 28a side of the full blades 28 through gaps between the plurality of full blades 28 adjacent to each other. The air having flowed through the gaps between the plurality of full blades 28 adjacent to each other flows from the end portion 29a side of the splitter blades 29 through gaps between the plurality of blades 27 adjacent to each other (full blades 28 and splitter blades 29). The air having flowed through the gaps between the plurality of blades 27 adjacent to each other is delivered to the radially outer side along the outer circumferential surface 26b of the main body portion 26 and the plurality of blades 27 while being directed toward the back surface 26c side.

That is, the end portions 28a of the full blades 28 are upstream ends of the full blades 28 in the flow direction of air. The end portions 29a of the splitter blades 29 are upstream ends of the splitter blades 29 in the flow direction of air. The end portions 28b of the full blades 28 are downstream ends of the full blades 28 in the flow direction of air. The end portions 29b of the splitter blades 29 are downstream ends of the splitter blades 29 in the flow direction of air.

At the upstream ends of the full blades 28 (end portions 28a), the short blade 29 is not present between the full blades 28, and hence the flow passage is not divided by the short blade 29. Therefore, a large amount of air flows into the gaps between the blades 27.

Further, as described above, the compressor impeller 22 includes the splitter blades 29 and the thinned portion 26e. Downweighting can be achieved by the thinned portion 26e. The splitter blades 29 function as ribs. Therefore, the strength can be improved without increasing the air resistance in the thinned portion 26e.

FIG. 4 is an extraction view of the two-dot chain line portion of FIG. 3. In FIG. 4, there is illustrated a draw-out line a which extends in a direction perpendicular to the rotation axis of the compressor impeller 22 from a portion 29c of the end portion 29a of the short blade 29 on the radially innermost side. As illustrated in FIG. 4, the end portion 29a of the short blade 29 is slightly inclined with respect to a direction of a plane perpendicular to the rotation axis of the compressor impeller 22. The portion 29c of the short blade 29 on the radially innermost side is located on the most front end surface 26d side (left side in FIG. 4) of the short blade 29.

According to comparison between the draw-out line a and the thinned portion 26e, a deepest portion 26h of the thinned portion 26e reaches a position deeper than the end portion 29a of the short blade 29 on the front end surface 26d side. In the deepest portion 26h of the thinned portion 26e, a position in the rotation axis direction is located between the end portion 29a of the short blade 29 and the end portion 28a of the long blade 28. That is, the thinned portion 26e extends in the rotation axis direction to a position between the end portion 29a of the short blade 29 and the end portion 28a of the long blade 28. Herein, an example is given of a case in which the deepest portion 26h of the thinned portion 26e reaches a position deeper than the end portion 29a of the short blade 29 on the front end surface 26d side. However, the deepest portion 26h of the thinned portion 26e may extend to the position which is the same as the positions of the end portions 29a of the splitter blades 29 on the front end surface 26d side.

As described above, the strength of the compressor impeller 22 is improved by the splitter blades 29 and the rib 26g. Therefore, the deepest portion 26h of the thinned portion 26e can be extended to the position which is deeper than the end portion 29a of the short blade 29 on the front end surface 26d side. Alternatively, the deepest portion 26h of the thinned portion 26e can be extended to the position which is the same as the positions of the end portions 29a of the splitter blades 29 on the front end surface 26d side. In such a manner, further downweighting can be achieved.

The embodiment has been described above with reference to the attached drawings, but, needless to say, the present disclosure is not limited to the above-mentioned embodiment. It is apparent that those skilled in the art may arrive at various alternations and modifications within the scope of claims, and those examples are understood as naturally falling within the technical scope of the present disclosure.

For example, in the above-mentioned embodiment, description is made of the case in which the rib 26g is formed. However, the rib 26g may be omitted as long as at least the full blades 28 and the splitter blades 29 are formed. In the case in which the rib 26g is formed, for example, as compared to the case in which the rib extends in the radial direction, the air resistance in the thinned portion 26e can be suppressed when the compressor impeller 22 is rotated. That is, the degradation in efficiency can be suppressed while improving the strength.

Further, in the above-mentioned embodiment, description is made of the case in which the plurality of blades 27 include the full blades 28 and the splitter blades 29. However, the splitter blades 29 may be omitted as long as at least the rib 26g is formed. In this case, all of the blades 27 are the full blades 28. For example, in order to secure the amount of inflow air, the number of blades is reduced to a half by the omission of the splitter blades 29. However, the rib 26g is formed, and hence, as described above, the strength can be improved by the rib 26g, and the reduction in efficiency due to the air resistance of the rib 26g can be suppressed.

Further, in the above-mentioned embodiment, description is made of the case in which the thinned portion 26e is formed so that the thickness of the portion at which the back surface 26c is formed is substantially constant. However, the thickness of the portion at which the back surface 26c is formed is not always substantially constant. When the thinned portion 26e is formed so that the thickness of the portion at which the back surface 26c is formed is substantially constant, the following effect is attained. That is, for example, when the compressor impeller 22 is manufactured by, for example, injection molding, flowability during molding is improved.

Further, in the above-mentioned embodiment, description is made of the case in which the deepest portion 26h of the thinned portion 26e is located at the position which is the same as the positions of the end portions 29a of the splitter blades 29 on the front end surface 26d side. Description is also made of the case in which the deepest portion 26h of the thinned portion 26e reaches the position deeper than the end portions 29a. However, the deepest portion 26h of the thinned portion 26e may be shallower than the end portions 29a of the splitter blades 29 on the front end surface 26d side.

Further, in the above-mentioned embodiment, description is made of the electric supercharger C as an example. However, the above-mentioned configuration may be applied to a supercharger other than the electric supercharger C. Further, the above-mentioned configuration may be applied not only to the supercharger but also to, for example, an impeller for a centrifugal compressor. When the above-mentioned configuration is applied to the compressor impeller 22 of the electric supercharger C, further downweighting can be achieved by increasing the size of the thinned portion 26e. This is because the rotation speed of the compressor impeller 22 during use is relatively low, and hence the requested strength is not excessively high.

Further, in the above-mentioned embodiment, description is made of the compressor impeller 22 as an example. However, the above-mentioned configuration may be applied to a turbine impeller of a turobcharger.

In the above-mentioned embodiment, description is made of the case in which the compressor impeller 22 is made of CFRP. However, the compressor impeller 22 may be made of other materials such as aluminum alloy. When the compressor impeller 22 is made of CFRP, together with the above-mentioned configuration, further downweighting can be achieved, and the strength can be synergistically improved. This is because CFRP is light and has high strength.

### INDUSTRIAL APPLICABILITY

The present disclosure can be used for an impeller having a plurality of blades on an outer circumferential surface of a main body portion, and for a supercharger.

What is claimed is:

1. An impeller, comprising:
a main body portion which is increased in diameter from one side to another side in a rotation axis direction;
a thinned portion, which is formed in a back surface of the main body portion so as to be oriented toward the another side in the rotation axis direction, and is recessed toward the one side in the rotation axis direction;
a plurality of full blades which are formed on an outer circumferential surface of the main body portion so as to be oriented toward the one side in the rotation axis direction; and
a plurality of splitter blades, which are formed on the outer circumferential surface, and have end portions being located on the one side in the rotation axis direction and being positioned on the another side in the rotation axis direction with respect to the full blades.

2. An impeller according to claim 1, wherein the thinned portion has a deepest portion, which is located at a position being the same as positions of the end portions of the splitter blades or reaches a position deeper than the end portions.

3. An impeller according to claim 1, further comprising:
a cylindrical portion, which is formed on a back surface side of the main body portion, and protrudes toward the another side in the rotation axis direction with respect to the deepest portion of the thinned portion to serve as an outer wall of an insertion hole for receiving a shaft inserted to the insertion hole; and
a rib, which is arranged apart from the cylindrical portion in a radial direction of the shaft, and protrudes from the back surface of the main body portion toward the another side in the rotation axis direction and extends in a circumferential direction of the shaft.

4. An impeller according to claim 2, further comprising:
a cylindrical portion, which is formed on a back surface side of the main body portion, and protrudes toward the another side in the rotation axis direction with respect to the deepest portion of the thinned portion to serve as an outer wall of an insertion hole for receiving a shaft inserted to the insertion hole; and
a rib, which is arranged apart from the cylindrical portion in a radial direction of the shaft, and protrudes from the back surface of the main body portion toward the another side in the rotation axis direction and extends in a circumferential direction of the shaft.

5. An impeller, comprising:
a main body portion which is increased in diameter from one side to another side in a rotation axis direction;
a plurality of blades which are formed on an outer circumferential surface of the main body portion so as to be oriented toward the one side in the rotation axis direction; and
a thinned portion, which is formed in a back surface of the main body portion so as to be oriented toward the another side in the rotation axis direction, and is recessed toward the one side in the rotation axis direction;
a cylindrical portion, which is formed on a back surface side of the main body portion, and protrudes toward the another side in the rotation axis direction with respect to a deepest portion of the thinned portion to serve as an outer wall of an insertion hole for receiving a shaft inserted to the insertion hole; and
a rib, which is arranged apart from the cylindrical portion in a radial direction of the shaft, and protrudes from the back surface of the main body portion toward the another side in the rotation axis direction and extends in a circumferential direction of the shaft.

6. A supercharger, comprising the impeller according to claim 1.

7. A supercharger, comprising the impeller according to claim 5.
